(19) United States
(12) Patent Application Publication
(10) Pub. No.: US 2011/0099493 A1
(43) Pub. Date: Apr. 28, 2011

(54) IMAGE AUXILIARY DATA SEARCHING AND DISPLAYING METHOD AND DOCUMENT CAMERA USING SUCH METHOD

(75) Inventors: Cheng-Cheng Yu, Taipei (TW); Chun-Chi Huang, Taipei (TW); Chien-Hung Chen, Taipei (TW); Lien-Kai Chou, Taipei (TW)

(73) Assignee: AVERMEDIA INFORMATION, INC., Taipei (TW)

(21) Appl. No.: 12/828,953

(22) Filed: Jul. 1, 2010

(30) Foreign Application Priority Data
Oct. 26, 2009 (TW) 098136162

(51) Int. Cl. G06F 17/30; H04N 5/228; G06F 3/048

(52) U.S. Cl. 715/764; 348/222.1; 707/722; 348/E05.031; 707/E17.014

(57) ABSTRACT

An image auxiliary data searching and displaying method is used in a document camera. The document camera includes a processor and a user interface. The processor is accessible to a database. The image auxiliary data searching and displaying method includes steps of performing an image-selecting operation on an image of the to-be-displayed object via the user interface to generate a target image, processing the target image by the processor to generate a target characteristic property, searching the database by the processor according to the target characteristic property so as to generate a search result, and simultaneously displaying at least one image auxiliary data from the search result and the image of the to-be-displayed object for comparison.

### FIELD OF THE INVENTION

The present invention relates to an image auxiliary data searching and displaying method, and more particularly to an image auxiliary data searching and displaying method for use in a document camera. By means of an image recognition technology, image auxiliary data associated with subject matters of a real-time image and the real-time image are simultaneously shown.

### BACKGROUND OF THE INVENTION

A document camera (also referred as a visual presenter, a digital visual presenter, a digital visualizer or a document projector) is a special video camera designed to make a presentation, hold a meeting or give a lecture in classroom, boardroom, or conference. By using the document camera, the lecturers or the presenters may directly display images of presented object together with writing description in real time. In addition, the document camera can be used for their demonstrations or illustration.

Conventionally, it is inconvenient for making a presentation because the speech manuscripts, reference documents or drawings should have been previously scanned by an image scanner, transformed into an image file and then displayed on a computer monitor or a projector screen. Otherwise, the documents or drawings should have been previously printed on the transparent slides by a colorful or black-and-white printing technology. The use of the document camera may largely reduce the burden of preparing presentation and increase presentation diversity.

Generally, the document cameras have many useful functions associated with video camera or scanner, for example image capturing, image scanning and image outputting functions. Like digital video cameras, digital still cameras, surveillance cameras or PC cameras, the image pickup modules used in the document cameras for sensing images are usually CMOS (Complementary Metal-Oxide Semiconductor) image sensing modules or CCD (Charged Coupled Device) image sensing modules. In practice, the document camera is in communication with a single gun projector or a multi-gun projector. The captured images to be shown to the audience will be projected onto a projection screen through the projector. The captured images may be transmitted from the image pickup module to a television or a computer monitor so as to display live video images. In addition, the document camera is capable of capturing images of various types of presentation materials such as planar or three-dimensional objects.

FIG. 1 is a schematic diagram illustrating a conventional portable document camera for projecting an image of an object. As shown in FIG. 1, the portable document camera 10 has an image pickup module 11 such as a CCD or CMOS image sensing module. First of all, the object 1 to be projected is placed in front of the image pickup module 11. The image of the object 1 is captured or scanned by the image pickup module 11 and transmitted to a single gun projector 12. Then, the captured image is projected onto a projection screen 14 through the single gun projector 12, so that the image of the object 1 will be displayed on the projection screen 14.

FIG. 2 is a schematic diagram illustrating a conventional flatbed document camera for projecting images of an object. The flatbed document camera 20 further includes a platform 201. The object 2 to be projected is placed on the platform 201. In addition, the flatbed document camera 20 has a lighting module 211 for providing light compensation such that the image of the object 2 will be clearly captured by the image pickup module 21. Likewise, the image of the object 2 captured by the image pickup module 21 is transmitted to a single gun projector 22. The captured image is projected onto a projection screen 24 through the single gun projector 22, so that the image of the object 2 will be displayed on the projection screen 24.

As the applications of the document camera are gradually enhanced, the functions of the hardware or software of the document camera are developed toward user-friendliness and increased performance. For example, in a case that the document camera is remotely controlled according to a wireless transmission technology, the operating flexibility of the document camera is increased. Whereas, in a case that a small-sized display screen or monitor is installed on the main body of the document camera to simultaneously display the image to be project, the lecturer may preview the projected image while making a presentation. Moreover, the document camera may have one or more expansion ports or connecting interfaces. Via the expansion ports or connecting interfaces, the document camera may be in communication with a computer system to interactively display the accessed data. In addition, via the expansion ports or connecting interfaces, the document camera may be connected to a memory device, a touch screen or a handwriting board in order to expand the functions thereof. Hence, in addition to projecting images in real time, the images captured by the document camera may be stored into an external memory unit or a built-in memory unit.

However, the document camera with the functions of storing or recording images, pictures or associated reference data still has some drawbacks. For example, although the lecturer is able to access images, pictures or reference data from the external or built-in memory unit to facilitate making a presentation, it is difficult to effectively search the subject matters from abundant files or preset database. The lengthy process of searching the subject matters is detrimental to real-time presentation. Moreover, it is also difficult to search the stored small pictures or multiple side-by-side pictures in the preview mode.

Therefore, there is a need of providing an improved document camera so as to obviate the drawbacks encountered from the prior art.

### SUMMARY OF THE INVENTION

The present invention provides an image auxiliary data searching and displaying method for use in a document camera. By the image auxiliary data searching and displaying method, when the lecturer makes a presentation, the image of an object and the image auxiliary data from a search result are simultaneously shown in order to facilitate the performance of making the presentation.

In accordance with an aspect of the present invention, there is provided an image auxiliary data searching and displaying method for use in a document camera. The document camera includes a processor and a user interface. The processor is accessible to a database. The image auxiliary data searching and displaying method includes steps of: performing an image-selecting operation on an image of the to-be-displayed object via the user interface to generate a target image; processing the target image by the processor to generate a target characteristic property, searching the database by the processor according to the target characteristic property so as to generate a search result; and simultaneously displaying at least one image auxiliary data from the search result and the image of the to-be-displayed object.

In accordance with anther aspect of the present invention, there is provided an image auxiliary data searching and displaying method for use in a document camera. The document camera includes a processor and a user interface. The processor is connectable to an internet. The image auxiliary data searching and displaying method includes steps of: performing an image-selecting operation on an image of a to-be-displayed object via the user interface to generate a target image; uploading the target image to the internet by the processor; searching a network database by a network search engine of the internet according to the target image so as to generate a search result; downloading at least one image auxiliary data from the search result by the processor; and simultaneously displaying the image auxiliary data and the image of the to-be-displayed object.

In accordance with a further aspect of the present invention, there is provided a document camera having an image auxiliary data searching and displaying function. The document camera includes an image pickup module, a processor and a user interface. The image pickup module is for capturing an image of a to-be-displayed object, thereby generating a real-time signal. The processor is in communication with the image pickup module for receiving the real-time signal and outputting the image of the to-be-displayed object. The processor is also in communication with a memory unit and accessible to a database of the memory unit. The user interface is in communication with the processor for performing an image-selecting operation on the image of the to-be-displayed object, thereby generating a target image. The target image is processed by the processor to generate a target characteristic property. The processor searches the database according to the target characteristic property so as to generate a search result, so that at least one image auxiliary data from the search result and the image of the to-be-displayed object are for simultaneously displayed.

In accordance with a still further aspect of the present invention, there is provided a document camera having an image auxiliary data searching and displaying function. The document camera includes an image pickup module, a processor and a user interface. The image pickup module is used for capturing an image of a to-be-displayed object, thereby generating a real-time signal. The processor is in communication with the image pickup module for receiving the real-time signal and outputting the image of the to-be-displayed object. The processor is also connectable to an internet. The user interface is in communication with the processor for performing an image-selecting operation on the image of the to-be-displayed object, thereby generating a target image. The target image is uploaded to the internet by the processor. A network search engine of the internet searches a network database according to the target image so as to generate a search result. At least one image auxiliary data from the search result are downloaded by the processor, so that the image auxiliary data and the image of the to-be-displayed object are simultaneously displayed.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating a conventional portable document camera for projecting an image of an object;

FIG. 2 is a schematic diagram illustrating a conventional flatbed document camera for projecting images of an object;

FIG. 3A is a schematic diagram illustrating the architecture of a document camera according to a first embodiment of the present invention;

FIG. 3B is a schematic functional block diagram illustrating the document camera according to the first embodiment of the present invention;

FIG. 4 is a schematic diagram illustrating a step of performing an image-selecting operation via a handwriting sensor module of a user device according to the first embodiment of the present invention;

FIG. 5 is a schematic diagram illustrating a search result and a target image, which are simultaneously shown on a monitor;

FIG. 6 is a flowchart illustrating an image auxiliary data searching and displaying method according to the first embodiment of the present invention;

FIG. 7 is a schematic diagram illustrating a step of performing an image-selecting operation via a handwriting sensor module according to a second embodiment of the present invention;

FIG. 8A is a schematic diagram illustrating the architecture of a document camera according to the second embodiment of the present invention; and

FIG. 8B is a schematic functional block diagram illustrating the document camera according to the second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides an image auxiliary data searching and displaying method for use in a document camera in order to automatically search and display the image auxiliary data during a presentation. By means of an image recognition technology, the subject matter correlated with a target image is realized and thus a target characteristic property is generated. Then, search-match is performed on the target characteristic property and the auxiliary characteristic properties to generate a search result. As such, at least one image auxiliary data from the search result could be quickly acquired for comparison.

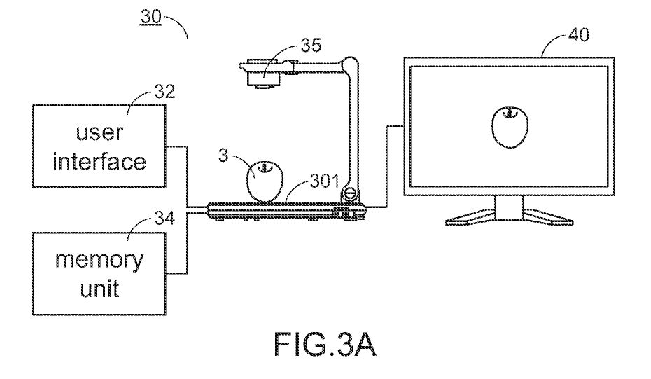

FIG. 3A is a schematic diagram illustrating the architecture of a document camera according to a first embodiment of the present invention. As shown in FIG. 3A, the document camera 30 includes a platform 301 and an image pickup module 35. The object 3 to be displayed (also referred as a to-be-displayed object) is placed on the platform 301. The image pickup module 305 is used for capturing an image of the to-be-displayed object 3, thereby acquiring a real-time image of the to-be-displayed object 3. Similarly, the image captured by the image pickup module 35 could be outputted and displayed in real time. Through a single gun projector or a multi-gun projector, the captured image will be transmitted to a projection screen (not shown) for display. In this embodiment, the document camera 30 is in communication with a monitor 40. The captured image could be transmitted from the image pickup module 35 to the monitor 40 so as to display the real-time image. While making a presentation, the lecturer may adjust the to-be-displayed object 3 according to the displaying result shown on the monitor 40.

Please refer to FIG. 3A again. The document camera 30 further includes a user interface 32 and a memory unit 34. The memory unit 34 is externally connected to the main body of the document camera 30, so that the memory unit 34 is in communication with the document camera 30. The user interface 32 is a main operating unit of the document camera 30. An example of the user interface 32 includes but is not limited to a mouse, a keyboard, a handwriting sensor module or a remote controller. Moreover, in addition to the real-time image of the to-be-displayed object 3, the image shown on the monitor 40 also includes a function-selective graphics menu, which is created by a graphics program. Via the user interface 32 (e.g. a mouse, a keyboard, a handwriting sensor module or a remote controller), the lecturer may choose and execute a desired function from the function-selective graphics menu, and the result will be displayed. In some embodiments, the user interface 32 is a hardware component (e.g. a function key set) installed on the main body of the document camera 30. Alternatively, the user interface 32 is an additional small-sized screen or touch screen of the document camera 30, so that the user interface 32 is operated according to a touch control technology.

An example of the memory unit 34 includes but is not limited to a portable hard disk, a memory card or a flash drive, which has a plug-and-play capability. The memory unit 34 is connected to the document camera 30 to expand functions of storing, recording and searching data, for example.

FIG. 3B is a schematic functional block diagram illustrating the document camera according to the first embodiment of the present invention. As shown in FIG. 3B, the document camera 30 further includes a processor 31. The image pickup module 35 and the user interface 32 are in communication with the processor 31. The memory unit 34 is externally connected to the main body of the document camera 30 for expanding the function of storing data. After the memory unit 34 is connected to an assembly interface 33, the memory unit 34 is in communication with the processor 31. The image pickup module 35 is used for capturing the image of the to-be-displayed object 3, thereby generating a real-time image signal. The real-time image signal in an analog format needs to be converted into digital format, and the digitalized real-time image signal will be received and processed by the processor 31. After the digitalized real-time image signal is processed by the processor 31, the processed signal needs to be converted into the analog format and then displayed on the monitor 40, or projected on a projection screen through a single gun projector or a multi-gun projector. Moreover, the document camera 30 further includes a frame buffer 36. After the image processing process, the data of the frame to be outputted are temporarily stored in the frame buffer 36.

In accordance with the present invention, an image-selecting operation is performed on the real-time image of the to-be-displayed object 3 to generate a target image, and then an image auxiliary data searching and displaying operation is performed on the target image. Alternatively, the image auxiliary data searching and displaying operation may be directly performed on the real-time image of a to-be-displayed object 3 without performing the image-selecting operation. In a case of no image-selecting operation, the subject matter correlated with the real-time image is usually obscure for performing the search-match operation. In a case that the background or the surrounding of the real-time image is simple or absent, the image-selecting operation may be omitted. The image auxiliary data searching and displaying operations for the real-time image and the target image are identical and will be illustrated later.

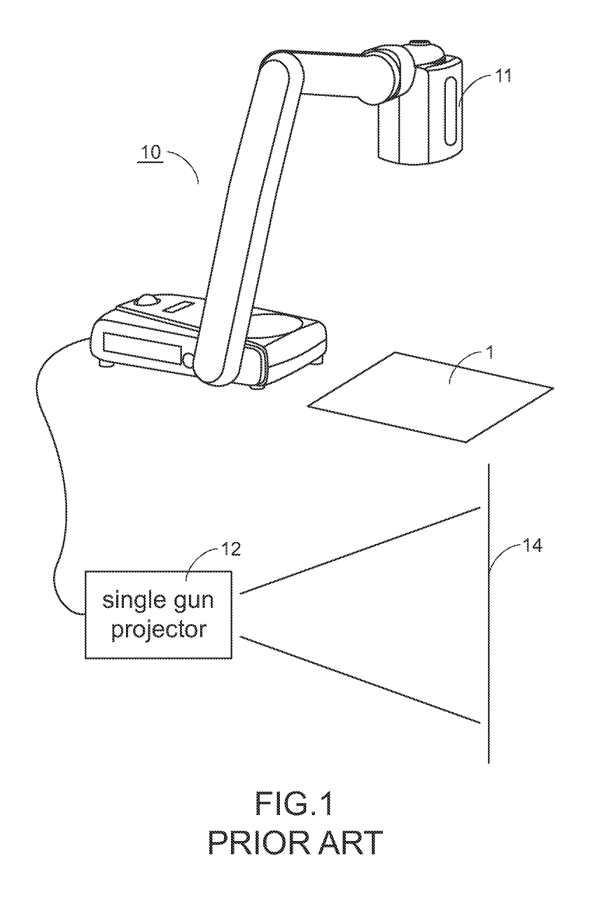

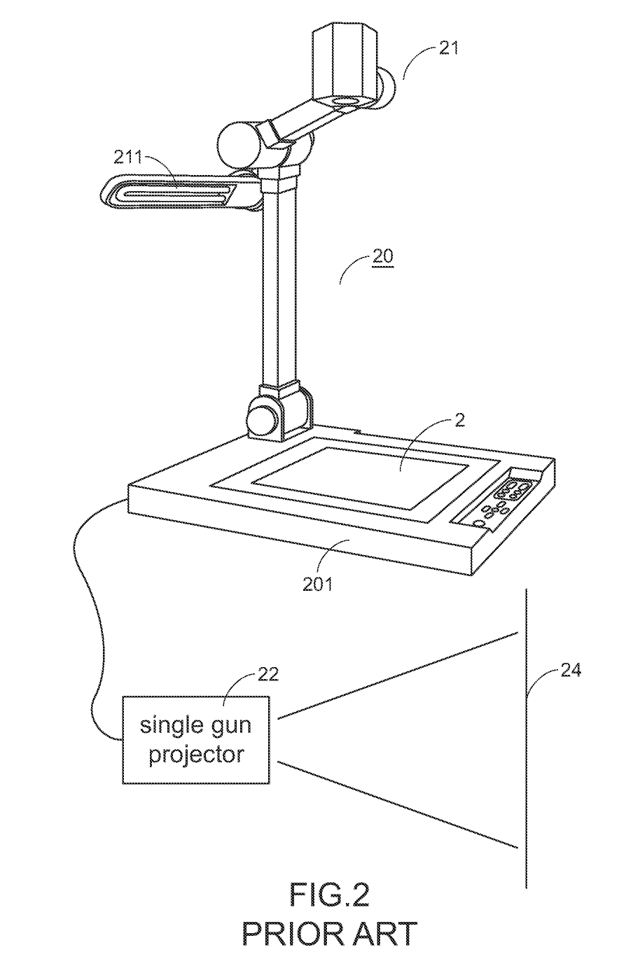

The image-selecting operation may be carried out according to the known image displaying technology, which is disclosed in for example US Patent Publication No. 2008/0231819 and entitled “Method of Displaying an Image for a Document Projector”. Please refer to FIGS. 1A˜1D of the mentioned US patent application. Firstly, a boundary frame is generated. Then, a real-time image of a to-be-displayed object and the boundary frame are overlapped with each other. The boundary frame separates the real-time image of the to-be-displayed object into an emphasized area and a not-emphasized area. The not-emphasized area is sheltered, but the emphasized area is displayed. In accordance with the present invention, the image-selecting operation may be performed on the image of a to-be-displayed object 3 via the user interface 32 (e.g. a mouse, a keyboard, a handwriting sensor module or a remote controller).

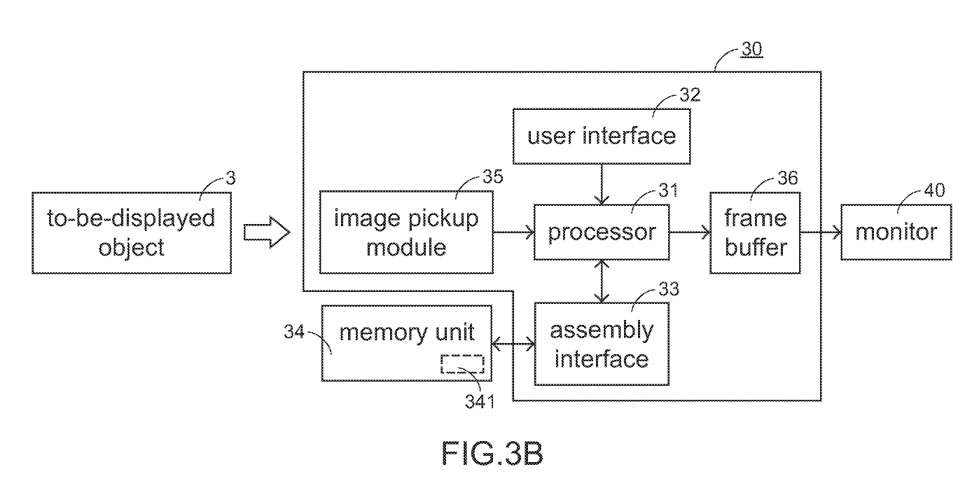

Take a handwriting module for example. The handwriting module includes a touch stylus 322 and a handwriting board 321 (see FIG. 4). By using the touch stylus 322 to write on the handwriting board 321, the area of the image to be displayed is circumscribed according to the handwriting track (see FIG. 4). As shown in FIG. 3A, the output image of the to-be-displayed object 3 shown on the monitor 40 may further include the images of the background or some other trivial articles. In other words, when the image-selecting operation is performed on the image of the to-be-displayed object 3, a target image A1 circumscribed with a dotted line (see FIG. 4) may be acquired.

Similarly, the purpose of circumscribing the area of the image to be displayed may be achieved by another user interface 32 (e.g. a mouse, a keyboard or a remote controller). For example, by moving a mouse in a tapping and dragging manner, or operating associated function keys/directional keys of a keyboard or a remote controller, the image-selecting operation could be performed. After the target image A1 is acquired, the target image A1 is further processed by the processor 31. In this embodiment, a database 341 is included in the memory unit 34. The database 341 contains many files previously prepared by the lecturer. During the presentation, the files could be previewed. For example, the stored small pictures or multiple side-by-side pictures could be displayed in the preview mode. Via the user interface 32, a desired file may be projected out for display. Hereinafter, the present invention will be illustrated by referring to a method of searching a file from the database 341 according to the target image A1.

To process the target image A1, image recognition about color distribution, shape or fraction is performed on the target image A1 in order to obtain a target characteristic property of the target image A1. For example, by analyzing the color values of respective pixels of the target image, the color distribution, shape and fraction will be realized. That is, after the image recognition, the target characteristic property is acquired. The image recognition may be implemented by a specified program installed in the processor 31. According to the target characteristic property, the subject matter correlated with or represented by the target image A1 will be effectively realized. As shown in FIG. 4, the target characteristic property indicates that the color values of respective pixels of the target image A1 corresponds to red tone. The pixels collectively define a spherical shape or an elliptical shape. Hence, after enough analysis, the target image A1 is considered to represent a subject matter of “an apple”.

In addition to analyzing the target image A1 of the to-be-displayed object 3, the files stored in the database 341 should be subject to the same image recognition procedure. That is, image recognition about color distribution, shape or fraction is performed on the image contents of the files included in the database 341 by the processor 31, thereby generating auxiliary characteristic properties. Each of the auxiliary characteristic properties indicates a subject matter correlated with or represented by respective files. Then, search-match is performed on the target characteristic property and the auxiliary characteristic properties by the processor 31 in order to realize the matching degree. In a case that the area, fraction or shape of a specified color in the target image is similar to that in one image file stored in the database 341, it is determined that there is a match or correlation between the target image and the searched image file. Alternatively, a more precise image recognition technology such as a fingerprint matching, face matching or retina matching recognition technology may be used in order to increase the recognizing reliability.

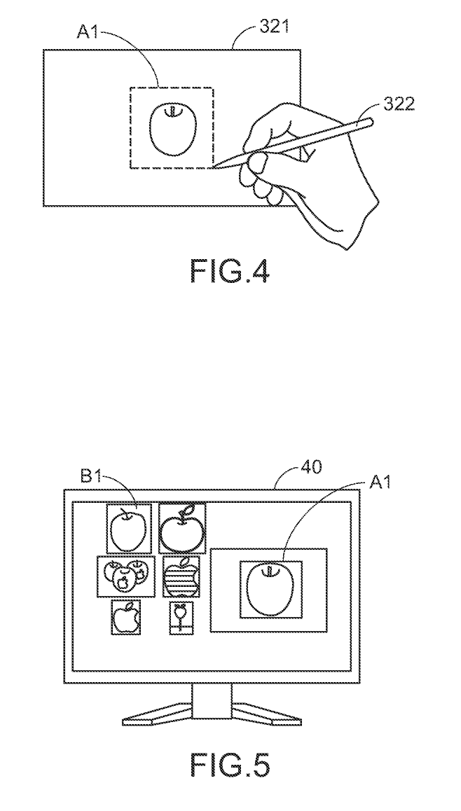

After the search-match is performed by the processor 31, a search result B1 including the match files is generated. The user may select at least one image auxiliary data from the search result. The selected image auxiliary data and the image of the to-be-displayed object 3 are simultaneously shown in order for comparison. FIG. 5 is a schematic diagram illustrating the search result B1 (or the selected image auxiliary data) and the target image A1 (or the image of the to-be-displayed object 3), which are simultaneously shown on a monitor 40. The search result B1 may be partially shown on the left portion of the monitor 40. Alternatively, the search result B1 may be completely shown on the monitor 40 in response to the operation of the user interface 32.

In a case that many match files are searched from the database 341, the match files are arranged and shown in a thumbnail preview mode. Alternatively, a scroll bar may be created beside the match files and adjusted to display more files. Moreover, via the user interface 32, each of the match files from the search result B1 may be selected and enlarged for facilitating comparison with the image of the to-be-displayed object 3. Because of improved and various buffering methods of the frame buffer 36, the way of showing the image auxiliary data and the image of the to-be-displayed object 3 may be modified. As shown in FIG. 5, the image auxiliary data and the image of the to-be-displayed object 3 are displayed in a side-by-side manner. Alternatively, the image auxiliary data and the image of the to-be-displayed object 3 are displayed in a picture in picture (PIP) manner. Under this circumstance, one or more match files and the image of the to-be-displayed object 3 are partially overlapped or non-overlapped, and have identical or different sizes of displaying zones.

From the first embodiment, it is understood that the image-selecting operation may enhance the recognizing efficacy of the image recognition technology. In addition, the processor 31 of the document camera 30 may implement the image recognition technology according to software or firmware design. Since the image recognition technology enhances the search-match efficacy, the lecturer could easily find out desired image auxiliary data while making a presentation. By taking advantage of the image auxiliary data searching and displaying function of the document camera 30, the image auxiliary data and the image of the to-be-displayed object 3 are simultaneously shown in order for comparison in real time.

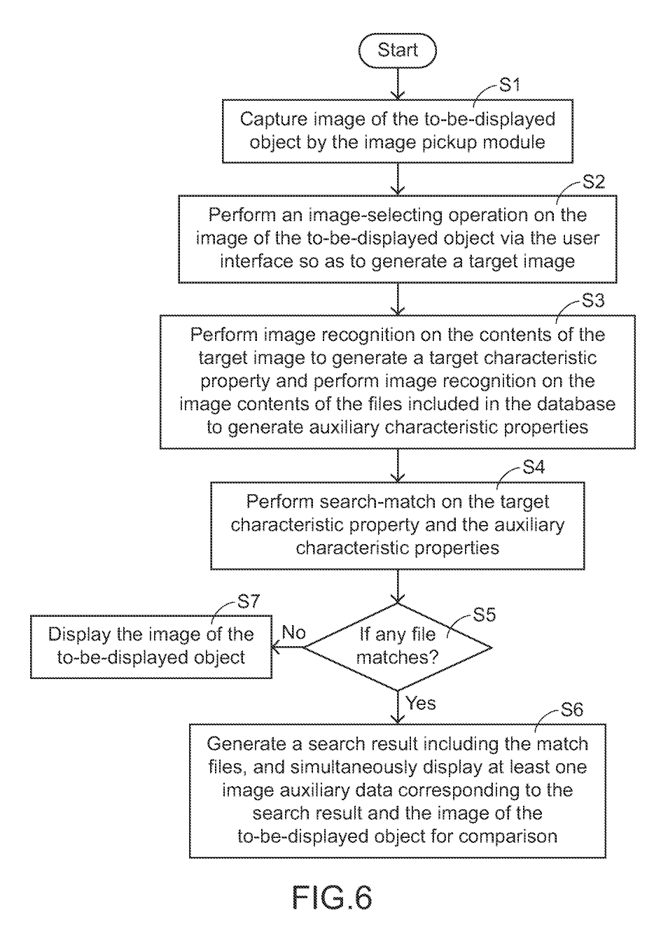

FIG. 6 is a flowchart illustrating an image auxiliary data searching and displaying method according to the first embodiment of the present invention. First of all, the image of the to-be-displayed object 3 is captured by the image pickup module 35, thereby generating a real-time image of the to-be-displayed object 3 (Step S1). Then, an image-selecting operation is performed on the image of the to-be-displayed object 3 via the user interface 32, thereby generating a target image A1 (Step S2). Next, image recognition about color distribution, shape or fraction is performed on the target image A1 by the processor 31, thereby generating a target characteristic property. In addition, image recognition about color distribution, shape or fraction is performed on the image contents of the files included in the database 341 by the processor 31, thereby generating auxiliary characteristic properties (Step S3). Then, search-match is performed on the target characteristic property and the auxiliary characteristic properties by the processor 31 (Step S4). If one or more of the auxiliary characteristic properties match the target characteristic property (Step S5), a search result B1 including the match files is generated. In addition, at least one image auxiliary data from the search result B1 and the image of the to-be-displayed object 3 are simultaneously displayed for comparison (Step S6). Whereas, once the target characteristic property does not match any of the auxiliary characteristic properties, only the image of the to-be-displayed object 3 is displayed (Step S7).

It is noted that numerous modifications of the first embodiment may be made as required. For example, the memory unit 34 may be a built-in expansion storage unit of the document camera 30. The database and the files prepared for the presentation may be stored in the built-in storage unit. Furthermore, the document camera 30 may be in communication with a remote memory unit (e.g. a network disk, a server or other computers) through a network (e.g. a local area network). In such situation, the database is included in the remote memory unit, and the processor of the document camera is accessible to the remote memory unit through the network.

In the first embodiment, the to-be-displayed object 3 is a physical object. Alternatively, the to-be-displayed object 3 may be one image file selected from the database 341. While making a presentation, the files stored in the database 341 may be previewed (for example in thumbnail preview images), and then the lecturer may select a file via the user interface 32. In such situation, the selected file is viewed as the to-be-displayed object. That is, after a file is selected from the database 341 and an image-selecting operation is performed on the selected file, a target characteristic property is generated. The image recognition is also performed on the image contents of the files included in the database 341, thereby generating auxiliary characteristic properties. Search-match is performed on the target characteristic property and the auxiliary characteristic properties, thereby acquiring desired image auxiliary data.

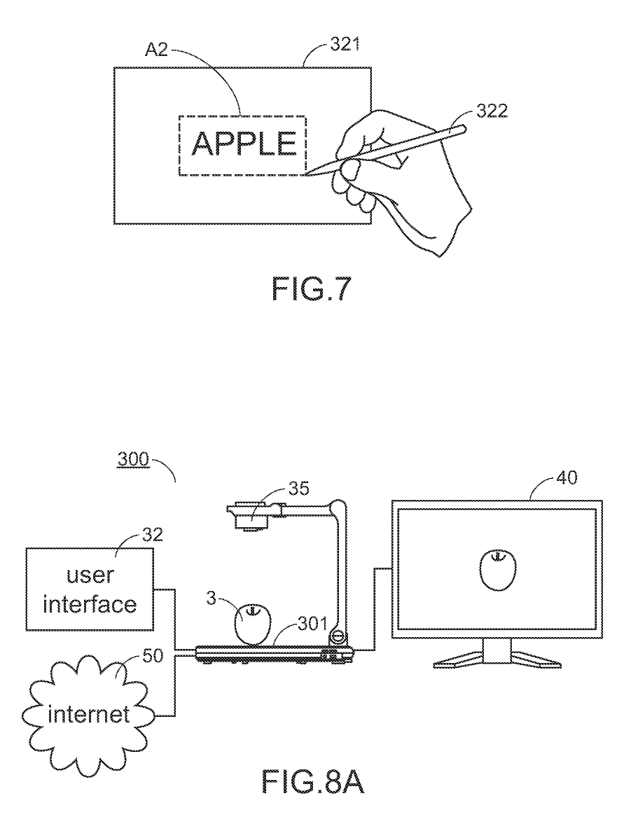

In some embodiments, the contents of the analyzed patterns (e.g. pictures or character images) may be converted into characters by the image recognition technology. According to this image recognition technology, the processor 31 is designed to be able to convert pictures into characters. FIG. 7 is a schematic diagram illustrating a step of performing an image-selecting operation via a handwriting sensor module according to a second embodiment of the present invention. By using the touch stylus 322 to write on the handwriting board 321, the area of a character image to be displayed is circumscribed according to the handwriting track. When an image-selecting operation is performed, a target image A2 circumscribed with a dotted line may be acquired. The contents of the target image A2 are converted into character(s) by the processor 31 according to the image recognition technology, thereby generating a target characteristic property. For example, as shown in FIG. 7, the target image A2 is recognized as a word “APPLE”.

Moreover, some information (e.g. file name, file description or abstract) contained in the files of the database 341 may be considered as auxiliary characteristic properties. Then, search-match is performed on the character-type target characteristic property and the character-type auxiliary characteristic properties of the files in the database 341 by the processor 31. After the search-match operation is performed by the processor 31, a search result including the match files is generated. The user may select at least one image auxiliary data from the search result. The selected image auxiliary data and the image of the to-be-displayed object 3 are simultaneously shown in order for comparison. For example, the files with information including the word “APPLE” are matched when the search-match is performed.

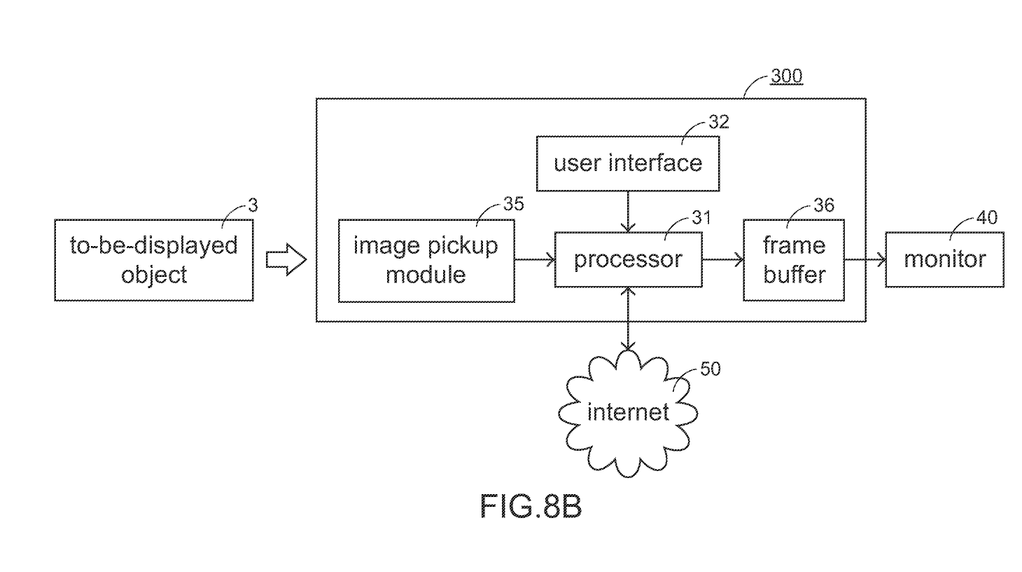

FIG. 8A is a schematic diagram illustrating the architecture of a document camera according to a second embodiment of the present invention. FIG. 8B is a schematic functional block diagram illustrating the document camera according to the second embodiment of the present invention. The image pickup module 35, the user interface 32, the platform 301 included in the document camera 300 of FIG. 8 are similar to those shown in the first embodiment, and are not redundantly described herein. In addition, the document camera 300 of this embodiment can be in communication with the internet 50. Thus, via the user interface 32, the lecturer may surf the internet 50. The image auxiliary data searching and displaying method of the second embodiment is similar to that of the first embodiment. First of all, the image of the to-be-displayed object 3 is captured by the image pickup module 35, thereby outputting a real-time image of the to-be-displayed object 3. While making a presentation, the lecturer may perform an image-selecting operation on the image of the to-be-displayed object 3 via the user interface 32, thereby generating a target image A1 (see also FIG. 4).

In this embodiment, the target image A1 is transmitted to the internet 50 from the processor 31 and a search is made according to the target image A1 by a network search engine of the internet 50. As known, most of portal websites have a data-searching function. By inputting a keyword, the character data or image data associated with the keyword will be searched. In addition, by uploading a designated image file to a portal website, the search result associated with the subject matters of the image file will be acquired. That is, the uploaded image file is firstly analyzed by performing image recognition, and then search-match is performed on the characteristic property of the uploaded image file and the auxiliary characteristic properties of the files stored in a network database of the website in order to acquire desired image auxiliary data.

In an embodiment, after the target image A1 is transmitted to the internet 50, image recognition is performed on the target image A1 by the network search engine of the internet 50. That is, image recognition about color distribution, shape or fraction is performed on the target image A1, thereby generating a target characteristic property. In addition, image recognition about color distribution, shape or fraction is also performed on the image contents of the files included in the network database of the website by the network search engine of the internet 50, thereby generating auxiliary characteristic properties. Then, search-match is performed on the target characteristic property and the auxiliary characteristic properties by the network search engine. If one or more of the auxiliary characteristic properties match the target characteristic property, a search result including the match files is generated. The search result is downloaded by the processor 31 through the internet 50 to be previewed. During the presentation, at least one image auxiliary data from the search result may be selected and downloaded, and the image auxiliary data and the image of the to-be-displayed object 3 are simultaneously shown for comparison. The method of selecting and displaying image auxiliary data from the search result is similar to that illustrated in FIG. 5, and may be modified as described in the first embodiment.

In the second embodiment, since the searching operation is performed by the network search engine of the internet, the search-match operation is no longer performed by the processor 31. In this situation, the processor 31 is responsible for uploading the target image A1 and receiving and downloading the search result made by the network search engine. Moreover, the second embodiment may be modified as described in the first embodiment. For example, the contents of the analyzed patterns of the target image A2 may be converted into characters by the image recognition technology. The recognized characters of the target image A2 have been illustrated in FIG. 7.

After image recognition is performed on the target image, a target characteristic property is generated. Search-match is performed on the characteristic property of the uploaded image file and the auxiliary characteristic properties of the files stored in a network database of the website in order to acquire desired image auxiliary data. The image auxiliary data are downloaded by the processor 31 for display. In other words, the search result may include the character-type network data. Via the user interface 32, the search result can be hyperlinked or browsed. On the other hand, the lecturer may select one or more files from the search result as image auxiliary data during the presentation. Moreover, for comparison, the image auxiliary data and the image of the to-be-displayed object 3 are displayed in a side-by-side manner or a PIP manner.

Moreover, the first embodiment and the second embodiment may be combined together. In a case that no suitable search result is acquired by the processor while searching the database of the built-in or external memory unit of the document camera or the remote memory unit through a local area network, the processor may be further connected to the internet and the searching operation is performed by the network search engine of the internet. As such, the search result and the image auxiliary data include more complete data. Alternatively, in a case that no suitable search result is acquired, the image of the to-be-displayed object or the target image may be stored in the database of the memory unit. Some information (e.g. file name, file description or abstract) may be included in the files associated with the image of the to-be-displayed object or the target image in order to expand the database for further presentation.

From the above description, the image auxiliary data searching and displaying method for use in a document camera is capable of automatically searching and displaying image auxiliary data. According to an image recognition technology, the subject matter correlated with a target image is realized. Search-match is performed on the target characteristic property and the auxiliary characteristic properties to generate a search result. As such, at least one image auxiliary data from the search result could be quickly acquired for comparison. In comparison with the conventional method of manually searching from abundant files or preset database or inputting keywords to the network search engine, the image auxiliary data searching and displaying method of the present invention is more user-friendly. By simply performing an image-selecting operation on an image of the to-be-displayed object, the image auxiliary data will be automatically acquired according to the programming procedures. As such, the burden of making a presentation is reduced and the presentation performance is enhanced. Therefore, the image auxiliary data searching and displaying method is effective to obviate the drawbacks encountered from the prior art.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image auxiliary data searching and displaying method for use in a document camera, the document camera comprising a processor and a user interface, the processor being accessible to a database, the image auxiliary data searching and displaying method comprising steps of:
performing an image-selecting operation on an image of a to-be-displayed object via the user interface, thereby generating a target image;
processing the target image by the processor, thereby generating a target characteristic property;
searching the database by the processor according to the target characteristic property so as to generate a search result; and
simultaneously displaying at least one image auxiliary data from the search result and the image of the to-be-displayed object for comparison.

2. The image auxiliary data searching and displaying method according to claim 1 wherein the database is included in a memory unit, wherein the memory unit is built in or externally connected to the document camera, or in communication with the processor through a local area network.

3. The image auxiliary data searching and displaying method according to claim 1, comprising steps of:
performing image recognition about color distribution, shape or fraction of the target image, thereby generating the target characteristic property;
performing image recognition about color distribution, shape or fraction on the image contents of files included in the database by the processor, thereby generating auxiliary characteristic properties; and
performing search-match on the target characteristic property and the auxiliary characteristic properties by the processor, thereby generating the search result including match files.

4. The image auxiliary data searching and displaying method according to claim 1, further comprising steps of:
performing image recognition about image-to-character conversion on the target image, thereby generating the target characteristic property; and
performing search-match on the target characteristic property and auxiliary characteristic properties of files stored in the database by the processor, thereby generating the search result including match files.

5. The image auxiliary data searching and displaying method according to claim 1, further comprising a step of selecting at least one of match files from the search result as the image auxiliary data via the user interface, and simultaneously displaying the image auxiliary data and the image of the to-be-displayed object.

6. The image auxiliary data searching and displaying method according to claim 1 wherein the image-selecting operation is performed by circumscribing a selected area of the image of the to-be-displayed object via the user interface, thereby generating the target image.

7. The image auxiliary data searching and displaying method according to claim 1 wherein the step of performing the image-selecting operation comprises sub-steps of:
generating a boundary frame;
overlapping the boundary frame with the image of the to-be-displayed object, so that the image of the to-be-displayed object is divided into an emphasized area and a not-emphasized area; and
sheltering the not-emphasized area and displaying the emphasized area.

8. The image auxiliary data searching and displaying method according to claim 1 wherein the image auxiliary data and the image of the to-be-displayed object are displayed in a side-by-side manner or a picture in picture (PIP) manner.

9. An image auxiliary data searching and displaying method for use in a document camera, the document camera comprising a processor and a user interface, the processor being connectable to an internet, the image auxiliary data searching and displaying method comprising steps of:
performing an image-selecting operation on an image of a to-be-displayed object via the user interface, thereby generating a target image;
uploading the target image to the internet by the processor;
searching a network database by a network search engine of the internet according to the target image so as to generate a search result;
downloading at least one image auxiliary data from the search result by the processor; and
simultaneously displaying the image auxiliary data and the image of the to-be-displayed object.

10. The image auxiliary data searching and displaying method according to claim 9, further comprising steps of:
performing image recognition about color distribution, shape or fraction on the target image by the network search engine, thereby generating a target characteristic property;
performing image recognition about color distribution, shape or fraction on the image contents of files included in the network database of the internet by the network search engine, thereby generating auxiliary characteristic properties; and
performing search-match on the target characteristic property and the auxiliary characteristic properties by the network search engine, thereby generating a search result including match files.

11. The image auxiliary data searching and displaying method according to claim 9, further comprising steps of:
performing image recognition about image-to-character conversion on the target image by the network search engine, thereby generating a target characteristic property; and
performing search-match on the target characteristic property and auxiliary characteristic properties of files stored in the network database of the internet by the network search engine, thereby generating the search result including match files.

12. The image auxiliary data searching and displaying method according to claim 9, further comprising a step of selecting at least one of match files from the search result as the image auxiliary data via the user interface, and simultaneously displaying the image auxiliary data and the image of the to-be-displayed object.

13. The image auxiliary data searching and displaying method according to claim 9 wherein the image-selecting operation is performed by circumscribing a selected area of the image of the to-be-displayed object via the user interface, thereby generating the target image.

14. The image auxiliary data searching and displaying method according to claim 9 wherein the step of performing the image-selecting operation comprises sub-steps of:
generating a boundary frame;
overlapping the boundary frame with the image of the to-be-displayed object, so that the image of the to-be-displayed object is divided into an emphasized area and a not-emphasized area; and
sheltering the not-emphasized area and displaying the emphasized area.

15. The image auxiliary data searching and displaying method according to claim 9 wherein the image auxiliary data and the image of the to-be-displayed object are displayed in a side-by-side manner or a PIP manner.

16. A document camera having an image auxiliary data searching and displaying function, the document camera comprising:
an image pickup module for capturing an image of a to-be-displayed object, thereby generating a real-time signal;
a processor in communication with the image pickup module for receiving the real-time signal and outputting the image of the to-be-displayed object, wherein the processor is also in communication with a memory unit and accessible to a database of the memory unit; and
a user interface in communication with the processor for performing an image-selecting operation on the image of the to-be-displayed object, thereby generating a target image,
wherein the target image is processed by the processor to generate a target characteristic property, and the processor searches the database according to the target characteristic property so as to generate a search result, so that at least one image auxiliary data from the search result and the image of the to-be-displayed object are for simultaneously displayed.

17. The document camera according to claim 16 wherein the memory unit is built in the document camera, externally connected to an assembly interface of the document camera, or connected to a local area network which is connected to the processor, to communicate with the processor.

18. The document camera according to claim 16 wherein the processor performs image recognition about color distribution, shape or fraction on the target image to generate the target characteristic property; performs image recognition about color distribution, shape or fraction on the image contents of files included in the database to generate auxiliary characteristic properties, and performs search-match on the target characteristic property and the auxiliary characteristic properties to generate the search result including match files.

19. The document camera according to claim 16 wherein the processor performs image recognition about image-to-character conversion on the target image to generate the target characteristic property; and performs search-match on the target characteristic property and auxiliary characteristic properties of files stored in the database to generate a search result including match files.

20. The document camera according to claim 16 wherein the user interface includes a mouse, a keyboard, a handwriting sensor module or a remote controller, and the image-selecting operation is performed by circumscribing a selected area of the image of the to-be-displayed object via the mouse, the keyboard, the handwriting sensor module or the remote controller, thereby generating the target image.

21. A document camera having an image auxiliary data searching and displaying function, the document camera comprising:
an image pickup module for capturing an image of a to-be-displayed object, thereby generating a real-time signal;
a processor in communication with the image pickup module for receiving the real-time signal and outputting the image of the to-be-displayed object, wherein the processor is also connectable to an internet; and
a user interface in communication with the processor for performing an image-selecting operation on the image of the to-be-displayed object, thereby generating a target image,
wherein the target image is uploaded to the internet by the processor, a network search engine of the internet searches a network database according to the target image so as to generate a search result, and at least one image auxiliary data from the search result are downloaded by the processor, so that the image auxiliary data and the image of the to-be-displayed object are simultaneously displayed.

22. The document camera according to claim 21 wherein image recognition about color distribution, shape or fraction is performed on image contents of files included in the database by the network search engine to generate auxiliary characteristic properties, and search-match is performed on the target characteristic property and the auxiliary characteristic properties by the processor to generate the search result including match files.

23. The document camera according to claim 21 wherein search-match is performed on the target characteristic property and auxiliary characteristic properties of files stored in the network database of the internet by the network search engine, thereby generating the search result including match files.
